(19) United States
(12) Patent Application Publication
(10) Pub. No.: US 2011/0090395 A1
(43) Pub. Date: Apr. 21, 2011

(54) METHOD FOR REUSE OF CRT MONITORS

(76) Inventors: Lekha Nair, Nashua, NH (US); Meera Nair, Nashua, NH (US); Saniya Shah, Nashua, NH (US); Avvinash Radakrishnan, Nashua, NH (US)

(21) Appl. No.: 12/650,348

(22) Filed: Dec. 30, 2009

Related U.S. Application Data
(60) Provisional application No. 61/253,429, filed on Oct. 20, 2009.

(51) Int. Cl. H04N 7/01; H04N 11/20

(52) U.S. Cl. 348/441; 348/E07.003; 348/E11.021

(57) ABSTRACT

This product is a method for the reuse of Cathode Ray Tube computer monitors as HDTVs. It is an appliance that takes HD signals from antenna, cable or video devices and converts them to VGA signals, letting the CRT display a high-quality image. Using this product, millions of CRT monitors—that otherwise would be dispose of as E-Waste—can be reused, which helps the environment.

### RELATED APPLICATION

This application claims priority to U.S. Provisional Application Ser. No. 61/253,429 (entitled A Method for Reuse of CRT Monitors, filed Oct. 20, 2009) which is incorporated herein by reference in its entirety.

### FIELD

The invention relates to a method of reuse of CRT computer monitors as HDTVs.

### BACKGROUND

Today there are many computer monitors based on Cathode Ray Tube technology being thrown away and creating hazardous electronic waste throughout the world. Many of these computer monitors are still functioning and are only being thrown away because of the newer technology available. These monitors have high image resolution comparable to High Definition Television and are being put to waste by being discarded instead of being put to a better use. Regular high definition televisions are expensive and not every household can afford to have one. Using these discarded CRT monitors as low-cost HDTVs can solve two of the current social issues.

This new product idea helps reduce CRT monitors in e-waste by reusing them as HDTVs. This requires a adapter box that receives HD TV signals and converts it into video signal that can be displayed on a common CRT computer monitor. An old computer monitor is converted to a HDTV using this adapter box. This television will be in high definition format because the CRT monitor is a high resolution screen. This converter box which is the source of the HDTV costs much less than a regular high definition television. This will create an opportunity for those who cannot afford the current HDTVs to have high definition televisions at a reasonable price. This product idea would reduce the number of computer monitors being thrown out by reusing them, in turn saving the environment from the toxic chemicals which would be released from them. This also puts a use to the otherwise useless HD resolution screen and a computer monitor.

### SUMMARY

Our Invention Green TV is a HD converter box that can be connected to any ordinary Cathode Ray Tube Monitor and can generate High Definition video images on a computer screen (FIG. 2). Our product Green TV minimizes E-waste, helps us and the world to “go green ”because our invention increases the life of the already made products. Which are put to waste. Our product is applicable all over the world because there are many people ready to use our invention (FIG. 3).

### BRIEF DESCRIPTION OF THE DRAWINGS

FIG. 1 is a block diagram illustrating a converter for using a CRT monitor as a television according to an example embodiment.

FIG. 2 is a block diagram of an example system capable of executing programming for example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A converter appliance 100 accepts HD video signals and converts them to a VGA signal that can be displayed on computer monitors 101. The computer monitor 101 is used to view the converted video signals. In one embodiment, a connector 102 is used to connect the VGA cable to the converter appliance 100. A connector 103 may be used for headphones 104. A connector 105 is provided for connecting speakers 106 to the converter 100. A connector 107 may be used to coupled DVD or Blu-Ray players 108. A connector 109 may be provided for connecting to an antenna 110. Finally, a remote controller 111 may be used to control the converter 100 and optionally the CRT monitor.

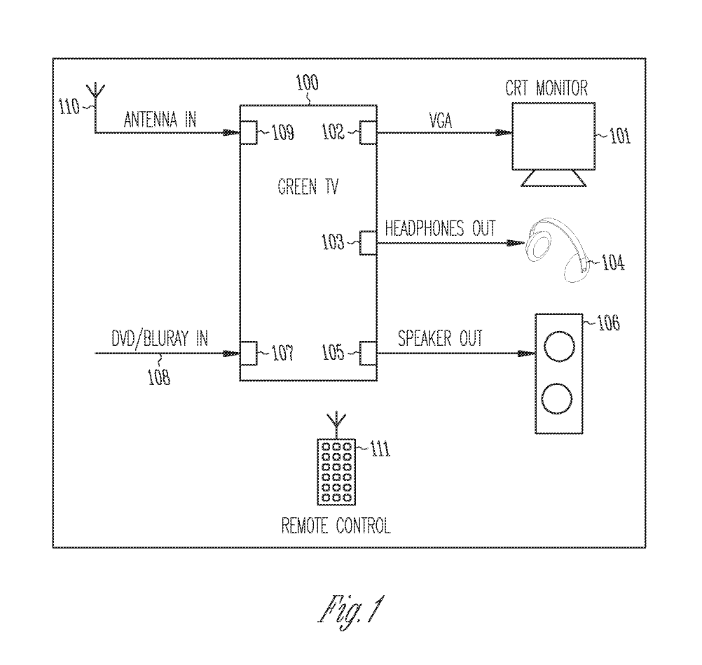

In FIG. 1, the converter 100 is referred to as a Green TV, and accepts inputs from HD/DTV or a Cable Box and it generates audio and video signals. The result of this Input are XGA resolution signals provided to a Computer Monitor. The Use of Headphones will provide HiFi Sounds. Green TV also plays DVD or Blu Ray Discs, which can be heard on an External Speakers which can be hooked up to our Invention. A Remote Control can be used for all standard TV operations.

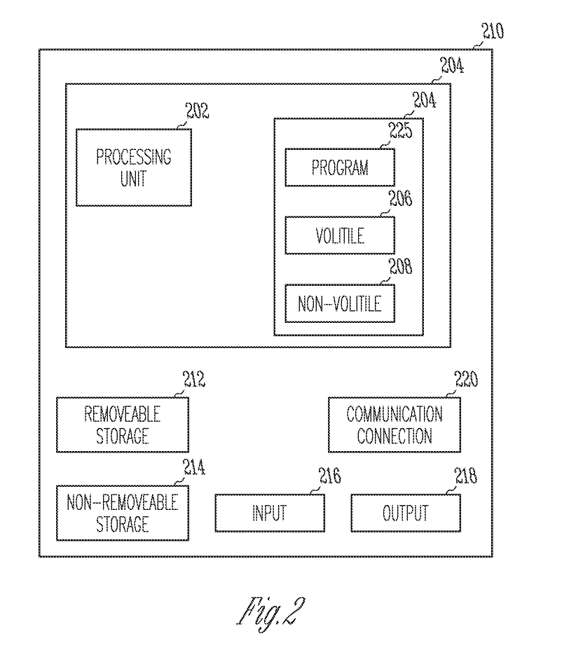

A block diagram of an example system capable of executing programming for performing the above algorithm is shown in FIG. 2. The system shown may include many more functions than needed by the Green TV, and may be simplified to an all hardware solution in some embodiments.

A general computing device in the form of a computer 210, may include a processing unit 202, memory 204, removable storage 212, and non-removable storage 214. Memory 204 may include volatile memory 206 and non-volatile memory 208. Computer 210 may include—or have access to a computing environment that includes—a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 210 may include or have access to a computing environment that includes input 216, output 218, and a communication connection 220. The computer may operate in a networked environment using a communication connection to connect to one or more remote computers. The remote computer may include a personal computer (PC), server, router, network PC, a peer device or other common network node, Or the like. The communication connection may include a Local Area Network (LAN), a Wide Area Network (WAN) or other networks.

Computer-readable instructions stored on a computer-readable medium 225 are executable by the processing unit 202 of the computer 210. A hard drive, CD-ROM, and RAM are some examples of articles including a computer-readable medium.

The Abstract is provided to comply with 37 C.F.R. §1.72(b) is submitted with the understanding that it will not be used to interpret or limit the scope or meaning of the claims.

The following statements are potential claims that may be converted to claims in a future application. No modification of the following statements should be allowed to affect the interpretation of claims which may be drafted when this provisional application is converted into a regular utility application.

1. A method to reuse discarded functioning computer monitors as digital televisions using a video converter to generate compatible video signal acceptable by the monitor.

2. The method of claim 1 and further comprising:
providing a high definition video input signal to the video converter; and
generating the video signal as a video graphics adapter (VGA) signal.

3. The method of claim 2 wherein the computer monitors are cathode ray tube (CRT) computer monitors.

4. The method of claim 3 wherein the VGA signals has a resolution of at least 640×480 pixels in 16 colors.

5. A converter box comprising:
an input to accept high definition video signals from an antenna or cable source;
circuitry to generate a signal to provide computer monitor video signals suitable for display on a cathode ray tube (CRT) computer monitor; and
an output port to accept a cable to couple the computer monitor video signals generated by the circuitry to a CRT computer monitor.

6. The converter box of claim 5 wherein computer monitor video signals are video graphics adapter (VGA) signals.

7. The converter box of claim 5 wherein the VGA signal have a resolution of at least 640×480 pixels in 16 colors.

8. The converter box of claim 5 and further comprising a connector for headphones.

9. The converter box of claim 5 and further comprising a connector for speakers.

10. The converter box of claim 5 and further comprising a connector for a DVD or Blu-Ray player.

11. The converter box of claim 5 and further comprising a connector for an antenna.

12. The converter box of claim 5 wherein the circuitry is configured to receive commands from a remote control device.
